(19) United States
(12) Patent Application Publication
(10) Pub. No.: US 2010/0201879 A1
(43) Pub. Date: Aug. 12, 2010

(54) Customizable Picture-in-Picture

(75) Inventors: Luke VanDuyn, Highlands Ranch, CO (US); Daniel Rudolph, Castle Rock, CO (US)

Correspondence Address: DORSEY & WHITNEY LLP;on behalf of EchoStar Technologies, L.L.C., 370 Seventeenth St., Suite 4700, Denver, CO, 80202-5647, US

(73) Assignee: EchoStar Technologies L.L.C., Englewood, CO (US)

(21) Appl. No.: 12/370,526

(22) Filed: Feb. 12, 2009

(51) Int. Cl. H04N 5/45; H04N 9/74

(52) U.S. Cl. 348/565; 348/581; 348/E05.112; 348/E09.055

(57) ABSTRACT

In accordance with embodiments of the present disclosure, there is provide systems and methods for customizing picture-in-picture video images on a television. Specifically, in one embodiment, a television receiver for depicting multiple images on a single display is described. The television receiver includes a first receiver operative to receive a first video image, a second receiver operative to receive a second video image, a processor configured to overlay the first video image on a portion of the second video image, the processor in communication with the first and second receivers and a transmitter operatively coupled to the processor and the display, the transmitter operative to transmit the first and second video images to the display. The television receiver also includes a third receiver operative to receive a command to adjust the first video image with respect to the second video image and relay the command to the processor, wherein the processor adjusts the first video image with respect to the second video image in response to the command and the operation of adjusting the first video image with respect to the second video image comprises one of resizing the first video image, moving the first video image across the second video image and changing a transparency of the first video image.

### TECHNICAL FIELD

The inventive field relates generally to systems and methods for displaying video images on a television. More particularly, the inventive field relates to systems and methods for customizing picture-in-picture video images for televisions.

### BACKGROUND DISCUSSION

As technology advances, televisions continue to serve as a centerpiece for in-home entertainment. With ever increasing content available to viewers, viewers generally are able to enjoy precisely the type of programming, content, and/or entertainment they desire. For example, a single television may receive content provided from a number of content sources including: a subscription based content provider such as satellite or cable, media players such as DVD and BluRay Disc players, video game consoles and over-the-air content, among others.

Picture-in-picture functionality allows users to view video content, i.e., a “picture,” from more than one program from a single source, or more than one source, concurrently on a television screen. Generally, the placement and sizing for picture-in-picture is limited to up to five preset positions. Specifically, an inset picture may have a preset size and be located in one quadrant of a television screen or, in some instances, side-by-side with a primary picture.

### SUMMARY

In accordance with embodiments of the present disclosure, there is provide systems and methods for customizing picture-in-picture video images on a television. Specifically, in one embodiment, a television receiver for depicting multiple images on a single display is described. The television receiver includes a first receiver operative to receive a first video image, a second receiver operative to receive a second video image, a processor configured to overlay the first video image on a portion of the second video image, the processor in communication with the first and second receivers and a transmitter operatively coupled to the processor and the display, the transmitter operative to transmit the first and second video images to the display. The television receiver also includes a third receiver operative to receive a command to adjust the first video image with respect to the second video image and relay the command to the processor, wherein the processor adjusts the first video image with respect to the second video image in response to the command and the operation of adjusting the first video image with respect to the second video image comprises one of resizing the first video image, moving the first video image across the second video image and changing a transparency of the first video image

In accordance with another embodiment, a method of customizing an inset video image in a picture-in-picture configuration for display by a television is provided, the method includes receiving a first and second video image, creating a combined video image from the first and second video images by the placing the first video image within the second video image, displaying the combined video image on a television, and customizing the first image by selecting the first video image using an actuation device of a remote control and dragging and dropping the first video image to a new location within the second video image.

In accordance with yet another embodiment, there is disclosed a method of adjusting the size or location of an inset video image on a television. The method includes activating picture-in picture functionality and interpreting user input as selecting to adjust size or location of the inset video image. Additionally, the method includes adjusting size or location of the inset video image.

### BRIEF DESCRIPTION OF THE DRAWINGS

Various aspects of the present invention may be better understood upon reading the following detailed description of non-limiting embodiments and examining the accompanying drawings, in which:

FIG. 1 illustrates a television system in accordance with an embodiment of the present disclosure.

FIG. 2 is a block diagram of a direct broadcast satellite system and set-top box in accordance with an embodiment of the present disclosure.

FIGS. 3A-D illustrate various perspective views of a remote control for use with the television system of FIG. 1 in accordance with an embodiment of the present disclosure.

FIG. 4 illustrates a screen shot of the television of FIG. 1 displaying an on-screen menu in accordance with an embodiment of the present disclosure.

FIGS. 5-8 are screen shots of the television of FIG. 1 displaying video images in a customizable picture in picture configuration in accordance with embodiments of the present disclosure.

FIG. 9 is a flowchart illustrating a technique for adjusting the size or location of an inset video image in accordance with an embodiment of the present disclosure.

### DETAILED DESCRIPTION OF EMBODIMENTS

The embodiments shown in the figures illustrate systems and methods that may provide an enhanced television viewing experience through customizable picture-in-picture functionality. As will be understood from this disclosure, the enhancements relate to enabling drag-and-drop functionality for an inset video picture so that the inset video picture may be placed at any location on a television screen, rather than only at preset positions. Additionally, a user may adjust the size of the inset video picture. Thus, it should be understood that the enhancements may allow conventional picture-in-picture functionality, such as providing preset location and size for inset video picture, while providing additional functionality to allow a user to customize a viewing experience.

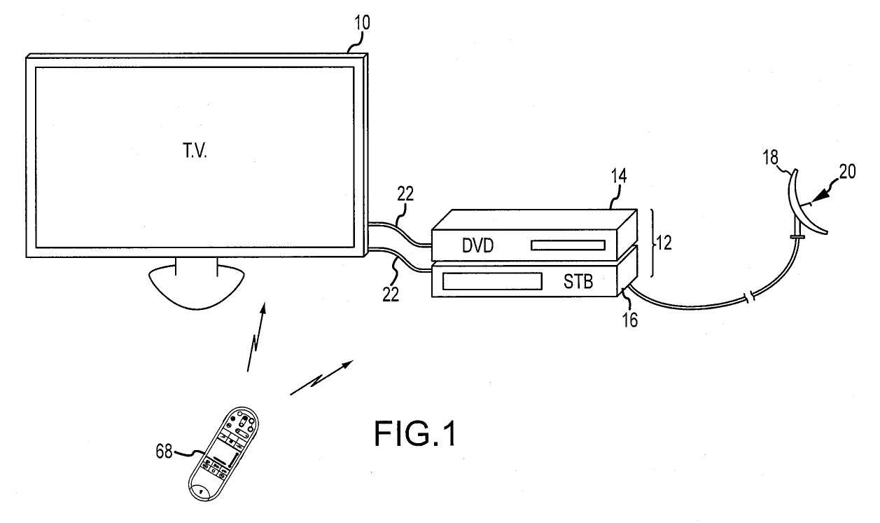

FIG. 1 illustrates a television 10 configured to display visual content, such as video images or still image content received from content sources 12, for example. The television 10 may be one of any of the various types of commercially available televisions including, for example a cathode-ray tube (“CRT”), liquid crystal display (“LCD”), light emitting diode (“LED”), organic LED, plasma, digital light processing, (“DLP”), etc. Alternatively, the television 10 may be a projector with a corresponding display screen. The television 10 may be configured to display standard definition signals, high definition signals, or any other level of definition signals. The television 10 may also display images in a variety of aspect ratios, such as a 4:3 aspect ratio or a 16:9 aspect ratio. In addition to visual content, the television 10 may be configured to output audio content received from the sources 12.

As shown, the multiple content sources 12 may include a DVD player 14 and a set-top-box (“STB”) 16. In other embodiments, the television 10 may be connected to more or fewer content sources. Additionally, there may be different types and different combinations of content sources 12. For example, the television 10 may be configured to receive video content directly from a VHF/UHF antenna (not shown). Additionally, or alternatively, the television 10 may receive content from a BluRay Disc player, a video game console, and/or a VHS player, for example, among others.

The television 10 and the content sources 12 may be communicatively coupled via any standard video communication conduit(s) 22, such as, coaxial cables, component cables, S-video cables, HDMI cables, fiber optics, etc. For example, the DVD player 14 may be coupled to the television 10 using an S-video cable and the STB 16 may be coupled to the television using an HDMI cable. Additionally, more than one communication conduit may connect each of the content sources 12 to the television 10. For example, a plurality of HDMI cables may connect the STB 16 to the television 10 to so that the STB 16 may provide, for example, two channels of video and audio content concurrently to the television 10. The content received from the content sources 12 may be analog or digital and formatted for display on the television 10.

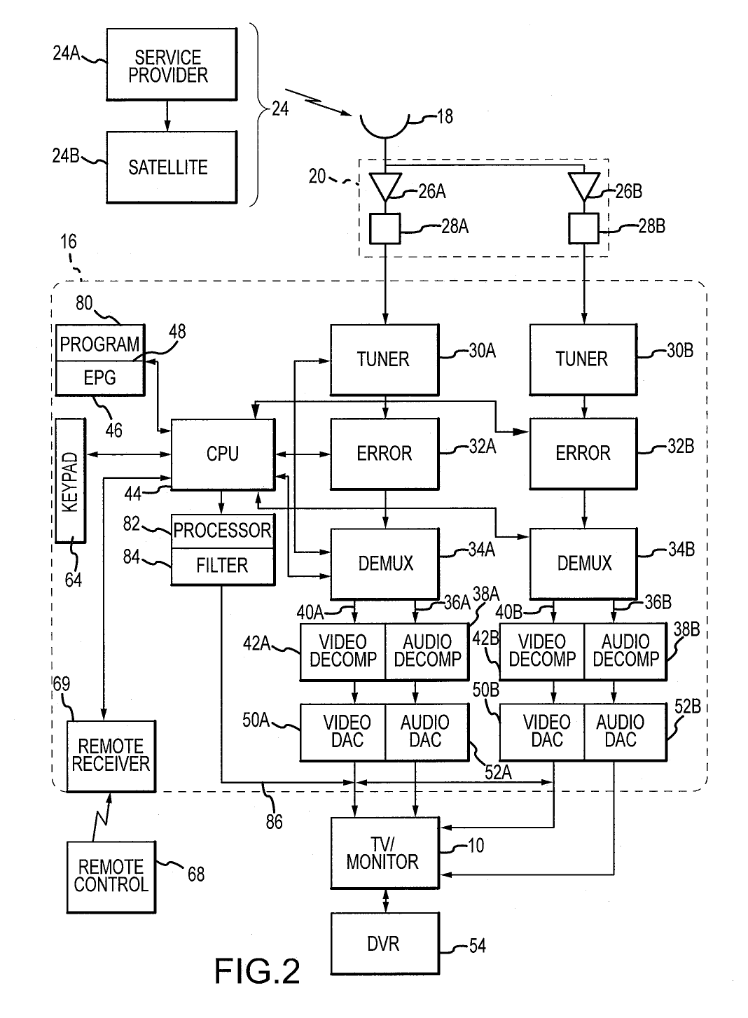

The STB 16 may be communicatively coupled to a satellite antenna 18 and together may be part of a direct broadcast satellite system incorporating packetized transmission according to a suitable standard, such as MPEG-2, MPEG-4, or the like. Although any programming source that includes television programming and program information, or otherwise transmits data associated with the television programming, is contemplated, the STB 16 and the associated direct broadcast system will serve as an exemplary basis for the disclosure contained herein. The transmitted signals may be received as downlinked signals by the satellite antenna 18. Front end processing of the satellite signals may be accomplished by a low noise block converter feed (LNBF) 20 provided in the antenna focal point. In order to receive more than one satellite signal concurrently, the satellite antenna 18 may include more than one LNBF 20, such as is commonly referred to as a dual LNBF. The STB 16 and the corresponding direct broadcast satellite system are illustrated in the simplified block diagram of FIG. 2.

As illustrated in FIG. 2, content for the direct broadcast satellite system may be provide by a service provider 24A that uplinks the content to a satellite 24B. The satellite 24B transmits the content toward Earth so a properly adjusted satellite antenna, such as satellite antenna 18 may receive the content. As mentioned above, the satellite antenna 18 may include one or more LNBFs 20. Each LNBFs 20 may include a converter module with a low noise amplifier 26 which receives the signals from the feed and a down converter 28 which converts the entire frequency band of the satellite signals to a lower frequency range that may be efficiently transmitted, for example, via coaxial cable to a client device, such as the STB 16. As shown, the satellite antenna 18 is a dual LNBF, i.e., it has two LNBFs. The LNBFs may receive communications from the same satellite 24B, or alternatively may receive communication from distinct satellites.

A tuner 30A-B may be provided for each LNBF of the satellite antenna 18 to enable selection specific channels from the downlinked signal. The ability to receive and tune to more than one channel concurrently may allow for picture-in-picture functionality using signals received via the satellite antenna 18. Error correction and packet synchronization modules 32A-B coupled to the tuners 30A-B may output a transport stream compliant with a video standard, e.g., MPEG-2, which may be directed to packet demultiplexers 34A-B. Various encoding or formats may be used.

The packet demultiplexers 34A-B may be integrated circuits that accept the packetized, time domain multiplexed data stream of the transport stream and routes the packets to various areas within the STB 16. Audio may be output as audio streams 36A-B, which may be respectively accepted and decompressed by audio decompressers 38A-B. Video may be output as video streams 40A-B, which may be respectively accepted and decompressed by video decompressers 42A-B. The audio streams 36A-B and the video streams 40A-B may be audio and video program elementary streams, respectively compliant with audio and video standards. In addition to routing packets of data, the packet demultiplexers 34A-B may also descramble encrypted data, provide various buffering of the formatted data, and handle a program clock reference to keep a local clock synchronized with the clock at the uplink center (e.g., service provider 22A). Data may be routed from the demultiplexers 34A-B to a central processing unit (CPU) 44, which may assemble the data into an electronic program guide (“EPG”) 46 stored in a memory or other storage medium 48.

The storage medium 48 may be implemented by one or more memory and/or storage technologies including, but not limited to flash, SDRAM, EEPROM, ferroelectric or other non-volatile memory, hard disk drive, semiconductor disk drive, and so on, and may store software or firmware containing the operating instructions to control or facilitate certain functions of the STB 16. For example, the storage medium 48 may include code to display more than one video image simultaneously on the screen using picture-in-picture functionality. Program 80 may represent code to enable such functionality, including on-screen menus and the ability to customize the video images. Specifically, the PIP program 80 may comprise an instruction set that allows a user to manipulate an inset picture, as discussed further below. The PIP program 80 may be implemented as hardware or, alternatively or additionally, may comprise a software program stored in the storage medium 48 that when executed provides users with the option of picture in picture functionality. For example, the PIP program may be implemented in an graphics chip (not shown) that is communicatively coupled to the CPU 44.

The video decompressers 42A-B and the audio decompressers 38A-B may accept one or more video streams 40A-B and/or audio streams 36A-B, respectively, and decompress them into baseband digital signals. The video streams 40A-B may then be fed to video digital-to-analog converters 50A-B and the audio stream 36A-B may be fed to video digital-to-analog converters 52A-B. The converters 50A-B and 52A-B may decode the digital signals and output resulting analog baseband signals to the television 10 and/or a DVR device 54, among others. As mentioned previously, the STB 16 may provide more than one set of video and audio signals to the television 10. Additionally, when the picture in picture functionality is operating, a secondary video image may be provided to a primary video image and, hence, only a single video stream may be provided to the television 10.

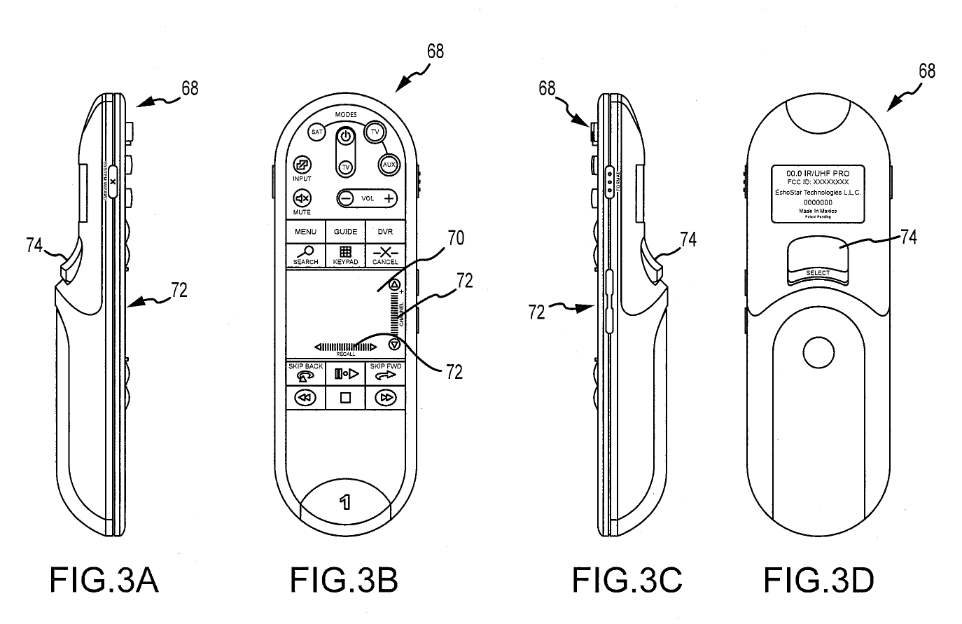

A user may control the operation of the STB 16 by interfacing with the STB 16 via a keypad 64 or a remote control device 68. The remote control device 68 may communicate with the CPU 44 by sending an infrared, radio frequency, or other wired or wireless signal to a remote receiver 69 that transfers commands to the CPU 44. The CPU 44 may then execute the commands. The remote control 68 is shown in greater detail in FIGS. 3A-D which illustrate a first side view (FIG. 3A), a top side view (FIG. 3B), a second side view (FIG. 3C), and a bottom view (FIG. 3D) of the remote control 68. As shown, the remote control 68 may have a reduced number of keys or buttons relative to conventional remote controls. Specifically, as illustrated, the remote control 68 may not have a number pad, for example. Rather, to utilize a number pad, the user may select a number pad button which may activate a virtual, on-screen number pad for a user to select numbers. Other functionality may similarly be engaged by activating on-screen menus and navigating the menus using the remote control 68.

In addition to the reduced number of buttons relative to conventional remote controls, the remote control 68 may include a touch sensitive region 70 located on a top surface 72 that may allow a user to control positioning of graphical objects displayed on the television 10, such as a cursor or an inset video image, for example. The touch sensitive region may include scroll zones 72 that may be used to scroll through on-screen menus and adjust sizing of inset video images, as will be discussed in greater detail below. The remote control 68 may also include an actuation device 74 located on a back surface 76. The actuation device 74 may be a push button configured to be used as a trigger in some embodiments to allow a user to easily select items or menu options displayed on the television. Other embodiments may implement alternative features that achieve similar functionality. In an alternative embodiment, for example, a scroll button may be implemented that may used to navigate menus, manipulate on-screen graphics and select items or options displayed on the television 10.

As mentioned above, on-screen directories, menus and program guides may help users manage the operation of the STB 16 and, thus, the content displayed on the television 10. The on-screen menus allow a user to select a content source and adjust parameters related to the content viewed on the television. To access such menus, user may select a menu button on the remote control 68. The central processing unit 44 may execute the program 70 which may provide a user with an on-screen menu for selection of the picture-in-picture functionality. Specifically, upon execution of the program 80, the processor 44 may output a graphic file to a processor 82. The processor 82 may process the graphic file and output a signal, which, after being filtered by a filter 84, may become a video baseband signal 76 that may be combined with the video baseband signal to be displayed on the television 10.

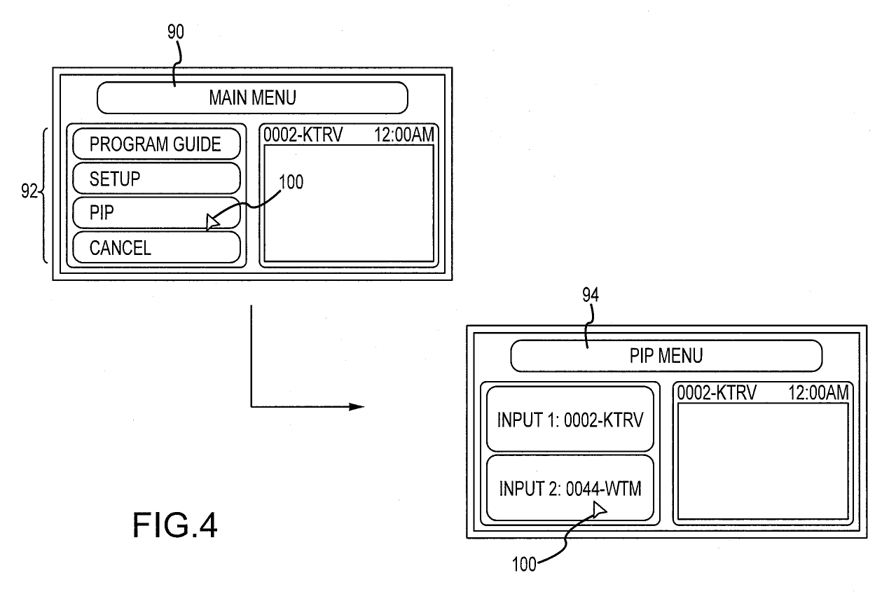

An example screen shot of the television 10 displaying the main menu 90 is shown in FIG. 4. As can be seen, a user is presented with various options 92 including (“PiP”) for picture-in-picture. The user may navigate the menu 90 to select any of the various options. For example, using a touch sensitive region 70 of the remote control 68 a user may manipulate or move a cursor 100 to place the cursor 100 over a desired menu option and selecting the option. For example, in one embodiment, the user may select the option by pressing the actuation device 74 on the remote control 68 or tapping on the touch sensitive region 70. Upon selection of the PiP option, a PiP menu 94 may be displayed to allow a user to select content for display on the television 10. In one embodiment, a first input (“Input 1”) may default to the input currently providing content to television screen and the user may select a second input (“Input 2”) for the video image that is to be inset in the picture in picture display. In another embodiment, rather than providing a second menu, an input currently providing content is set as the primary video image and the second input is selected as being the most recently viewed input, or if there is only one other input currently active or on, then the other activated input.

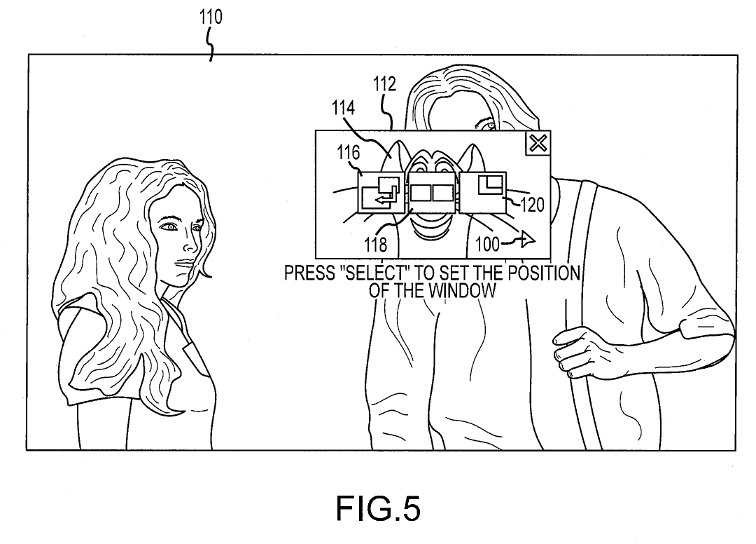

FIGS. 5-8 illustrate screen shots of the television 10 during picture in picture operation. These figures are intended to show various options available to customize the picture in picture display. As can be seen in FIGS. 5-8, a first input provides the primary content 110, and a second input provides secondary content 112, or the inset video image. The inset video image 112 may be located in conventional positions, such as in a corner of the screen or side-by-side with the primary content 110. Indeed, a menu 114 in the inset image may allow a user to simply select side-by-side display by selecting the side-by-side icon 116 using the cursor 100 and the actuation device 74 of the remote control. Additionally, a user may swap the positions of the primary and second images by selecting a “swap images” icon 118. Upon selection of the swap images icon 118, the inset image is swapped with the primary image, so that the former inset image is the primary image and visa-versa. Conforming with convention, such options generally provide the inset video image with a preset size in a preset location on the screen.

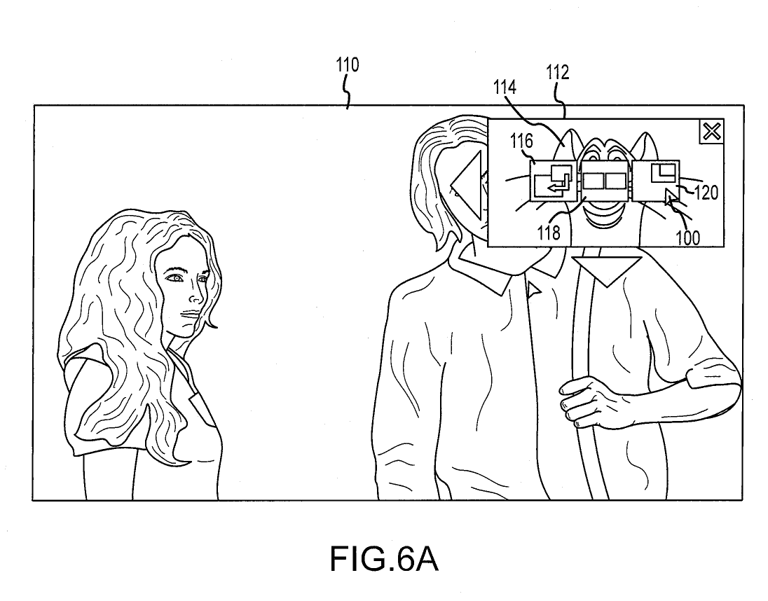

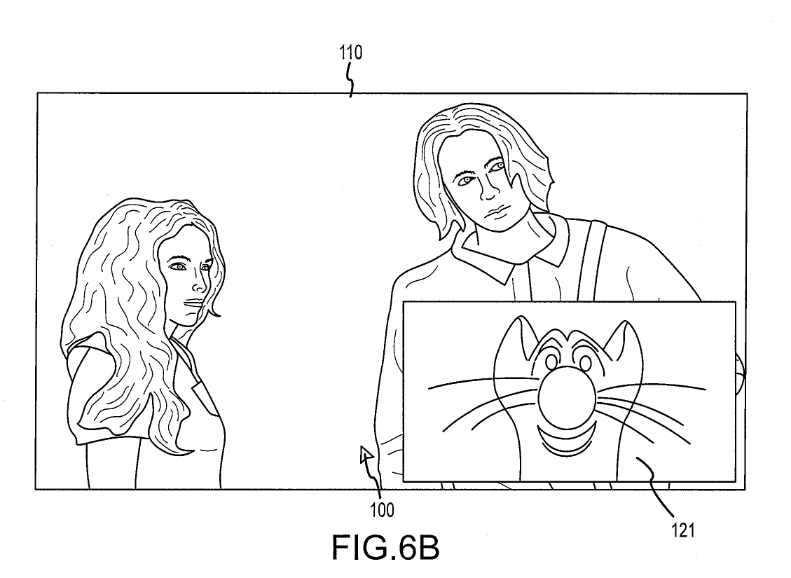

In accordance with the present disclosure, a user may manipulate both the size and location of the inset image to customize the viewing experience. For example, a “grow image” option 120 (FIG. 6) may be provided in the menu 114. Upon selection of the grow option 120, a user may adjust the size of the inset image. There may be various ways provided for the user to adjust the size of the inset image. In one embodiment, after selection of the grow option 120, the user may simply slide a finger along the scroll zones 72 of the touch sensitive region 70 of the remote 68 to either increase or decrease the size of the inset image.

The STB 16 may detect the selection of the grow image option 120 based on the location of the cursor 100 relative to the inset image 112 and, more particularly with respect to the menu 114. Upon recognizing that the grow image option 120 has been selected by the user, i.e., by receiving a signal from the remote indicating that the actuation device has been pressed while the cursor was over the grow image option 120, the STB 16 may adjust the size of the inset video image 112 based on signals received from the remote. For example, the STB 16 may interpret signals indicating movement on the scroll zones 72 as increasing or decreasing the size of the inset image. For example, the STB 16 may interpret signals from the remote indicating upward movement on the scroll zone 72 to shrink the inset image and downward movement to increase the size of the inset image. The operation of the STB 16 is thus controlled by the interpretation of signals received from the remote control 68 and/or the relative location of the cursor 100 to the inset image 112 and/or the on-screen menu 114.

In an alternative embodiment, the user may navigate the cursor 100 to a corner of the inset image 112, select the corner of the inset image using the actuation device 74 on the remote control 68, or by some other means, and drag the corner of the image using the touch sensitive region 70 of the remote control 68 to increase or decrease the size of the inset image 112. Upon release of the actuation device 74, the size of the inset image 112 may be set. Thus, the STB 16 detects the position of the cursor 100 relative to the inset video image 112, detects actuation of the actuation device 74, and interprets signals from the remote as indicating enlargement or shrinking of the inset video image 112.

In yet another alternative embodiment, the touch sensitive region 70 of the remote control 68 may be configured to sense multi-touch input such that the a user may touch the touch sensitive region 70 of the remote control 68 with two fingers and move the fingers apart to increase the size of the inset image 112 or pinch the fingers together to decrease the size of the inset image 112.

It should be understood, however, that the grow option 120 may also be executed using a conventional remote control. For example, a user may hold a select button while pressing navigation arrows on the remote to adjust the image size up or down. As such, the functionality described herein should not be read as being limited to the specific remote control described herein.

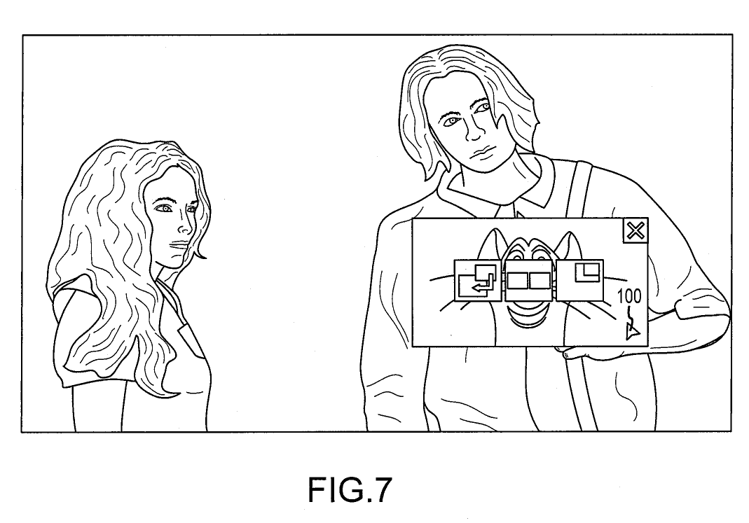

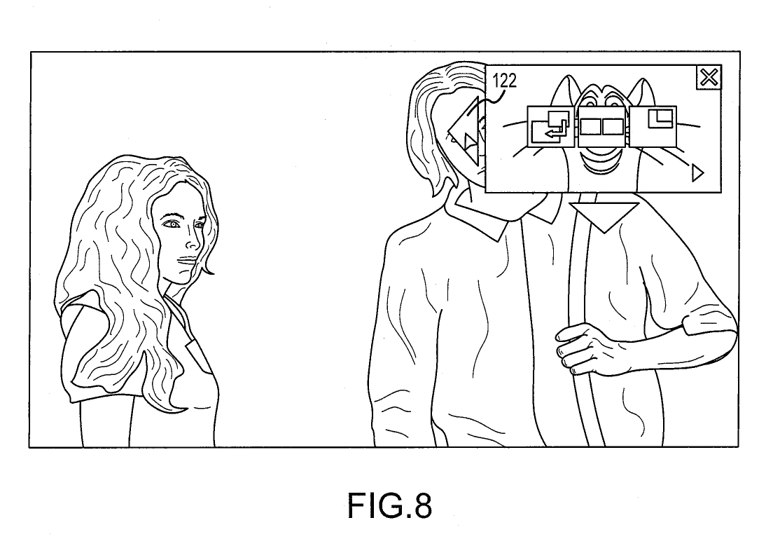

In addition to adjusting the size of the inset image 112, a user may move the inset image to a preferred location. To adjust the position of the inset video image, a user may move the cursor 100 over the inset image 112 and select the image by pressing the actuation device 74 of the remote control 68 and then move the cursor (optionally using the touch sensitive region of the remote control) while holding down the actuation device 74. Thus, the user may simply drag and drop the inset image 112 to a new location on the screen (FIG. 7). In an alternative embodiment, the user may move the cursor 100 over the inset image 112 and press the actuation button 74 to have positional arrows 122 appear on the edges of the inset image 112 as shown in FIG. 8. The user may navigate the cursor 100 so that it rests on the arrows 122 to move the inset image 112 in the direction in which the arrow over which the cursor is located points. In another alternative embodiment, the user may press the actuation device 74 while the cursor 100 is over an arrow to move the inset image incrementally (such as in discrete column or line movements, for example). In yet another alternative embodiment, the user may select the arrows and drag and drop the inset image 74. As such, in an actual implementation the various embodiments may be implemented alone or in combination.

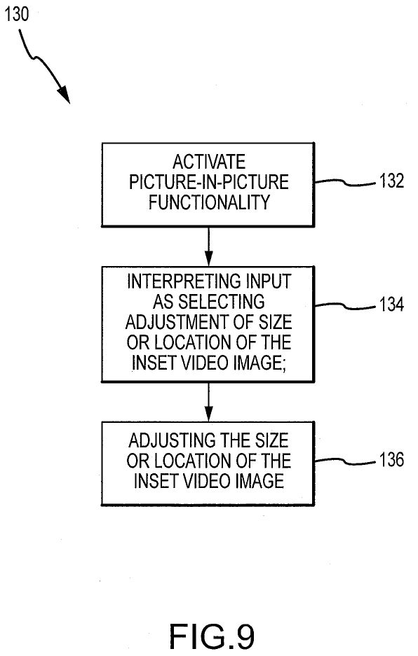

FIG. 9 illustrates a technique 130 for operating the STB 16 to adjust the size or location of an inset video image on a television. As illustrated, the technique 130 begins by activating picture-in picture functionality, as indicated at block 132. This may be accomplished by navigation on-screen menus or by receiving input indicating a PIP button on a remote has been actuated. The activation of the picture-in-picture functionality may launch a program, such as program 80, or may activate hardware to provide an inset video image over a portion of a primary image. Once the picture-in-picture functionality has been activated, the STB 16 may interpret user input as selecting to adjust size, transparency or location of the inset video image, as indicated at block 134. For example, as discussed in detail above, the location of the cursor relative to the inset video image or an onscreen menu coupled with actuation of an actuation device or a select button, for example, may be interpreted as adjustment of the inset video image. Upon interpretation of the received input, the STB 16 may adjust the size or location of the inset video image accordingly, as indicated at block 136.

It should be understood from the foregoing that the particular systems or methods of implementing an customized picture in picture is not critical and that any suitable approach as may be envisioned based on this disclosure may be employed. As such, the actual implementation of the systems and methods described herein may vary as appropriate or desired for a given application. Additionally, it should be understood that the customizable picture-in-picture functionality may be implemented in any device in communication with the television. Furthermore, the customizable picture in picture may be implemented in the television 10 and may be based on content receive from more than one content source.

Although various details have been described herein with reference to particular embodiments, it is to be understood that these embodiments are merely illustrative of principles and applications. It is therefore to be understood that numerous modifications may be made to the illustrative embodiments and that other arrangements may be devised without departing from the spirit and scope of the present invention.

What is claimed is:

1. A television receiver for depicting multiple images on a single display, comprising:
a first receiver operative to receive a first video image;
a second receiver operative to receive a second video image;
a processor configured to overlay the first video image on a portion of the second video image, the processor in communication with the first and second receivers;
a transmitter operatively coupled to the processor and the display, the transmitter operative to transmit the first and second video images to the display;
a third receiver operative to receive a command to adjust the first video image with respect to the second video image and relay the command to the processor; wherein
the processor adjusts the first video image with respect to the second video image in response to the command; and
the operation of adjusting the first video image with respect to the second video image comprises one of resizing the first video image, moving the first video image across the second video image and changing a transparency of the first video image.

2. The television receiver of claim 1 wherein the third receiver is a remote control interface.

3. The television receiver of claim 2 wherein the television receiver is configured to display and move a cursor based on commands received from the remote control.

4. The television receiver of claim 3 wherein the processor adjusts the first video image upon receiving signals from the remote control indicating actuation of an actuation device while the cursor is located over the first video image and indicating direction selection.

5. The television receiver of claim 4 wherein the adjusted size of the first video image corresponds to the direction of the received signal indicating direction.

6. The television receiver of claim 1 wherein the television receiver is configured to provide an on-screen menu within the first video signal.

7. The television receiver of claim 6 wherein the television receiver provides a cursor on the display and wherein the cursor moves corresponding to directional signals received at the third receiver, wherein the cursor is used to navigate the menu.

8. The television receiver of claim 3 wherein the television receiver generates directional graphical elements for display with the first video image, wherein the television receive moves the first video image in response to selection of the directional graphical elements.

9. The television receiver of claim 3 wherein the movement of the cursor in combination with receiving a signal indicating actuation of an actuation device on a remote control adjusts the first video image with respect to the second video image.

10. A method of customizing an inset video image in a picture-in-picture configuration for display by a television comprising:
receiving a first and second video image;
creating a combined video image from the first and second video images by the placing the first video image within the second video image;
displaying the combined video image on a television;
customizing the first image by selecting the first video image using an actuation device of a remote control and dragging and dropping the first video image to a new location within the second video image.

11. The method of claim 10 wherein selection of the first video image comprises navigating a cursor over the first video image.

12. The method of claim 10 comprising adjusting the size of the first image by selecting a corner of the first video image.

13. The method of claim 10 comprising adjusting the size of the first video image by selecting the first video image and using a scroll zone on the remote control.

14. The method of claim 10 comprising adjusting the size of the first video image by selecting the first video image and moving two fingers together or apart while touching a touch sensitive region on the remote control.

15. The method of claim 11 comprising adjusting the size of the first video image by selecting a corner of the first video image and moving the cursor toward or away from the first image.

16. The method of claim 10 wherein selection of the inset video image generates an on-screen menu within the first video image to allow for adjusting the size of the first video image relative to the second video image.

17. A method of adjusting the size or location of an inset video image on a television comprising:
activating picture-in picture functionality;
interpreting user input as selecting to adjust size or location of the inset video image; and
adjusting size or location of the inset video image.

18. The method of claim 17 wherein interpreting user input as selecting to adjust size or location of the inset image comprises:
determining the location of a cursor relative to the inset video image or an on-screen menu; and
detecting actuation of an actuation device.

19. The method of claim 17 wherein adjusting size or location of the inset image comprises interpreting input as indicating to increase or decrease the size of the inset video image or moving the inset video image away from preset locations relative to a primary video image.

20. The method of claim 18 further comprising interpreting actuation of a second device as moving the inset video image or adjusting the size of the inset video image.
